(19) United States
(12) Patent Application Publication
(10) Pub. No.: US 2013/0242044 A1
(43) Pub. Date: Sep. 19, 2013

(54) 2D TO 3D VIDEO CONVERSION BOX

(71) Applicant: Xian LI, Xiamen (CN)

(72) Inventor: Xian LI, Xiamen (CN)

(73) Assignee: XIAMEN SENHUI ELECTRONICS CO., LTD., Xiamen (CN)

(21) Appl. No.: 13/587,898

(22) Filed: Aug. 16, 2012

(30) Foreign Application Priority Data
Mar. 19, 2012 (CN) 201220100706.1

(51) Int. Cl. H04N 13/00

(52) U.S. Cl. 348/43; 348/E13.062; 348/E13.071; 348/E13.073

(57) ABSTRACT

A shutter 2D to 3D video conversion box, including an interface module, a decoding module, a control module, a sync signal amplifying and transmission module, and a sync signal receiving and processing module. The interface module, sync signal amplifying and transmission module, and control module are connected to the decoding module; and the interface module includes a HDMI signal input module and a HDMI signal output module. The decoding module converts 2D video signals into 3D digital signals. The control module controls the decoding process, and generates and transmits sync signals. The sync signal amplifying and transmission module amplifies and transmits the sync signals. The sync signal receiving and processing module receives and processes the sync signals sent from the control module.

### CROSS-REFERENCE TO RELATED APPLICATIONS

Pursuant to 35 U.S.C. §119 and the Paris Convention Treaty, this application claims the benefit of Chinese Patent Application No. 201220100706.1 filed Mar. 19, 2012, the contents of all of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a field of transmission and display of 3D videos, and more particularly to a shutter 2D to 3D video conversion box.

2. Description of the Related Art

3D image-forming principle is to use the principle of two cameras imitating the observing process of human eyes, that is, capturing two images in slightly different visual angles, and outputting each image to left or right eye. Active shutter 3D technology, namely timesharing shading technology or liquid crystal timesharing technology, is mainly realized by liquid crystal shutter glasses, which actually consist of two liquid crystal layers separately controlling the on/off state thereof. Each crystal layer has white and black states, in ordinary, the crystal layer is white, namely, being in a transparent state, and becomes dark when voltage is applied. Through a signal transmission device, synchronization between the 3D glasses and the display screen can be realized. The display screen alternatively displays images separately intended for the right and the left eyes. When displaying the images intended for the left eye, the left glass opens while the right glass closes, thus the left eye of the audience can only see the image intended for the left eye, while the right eye sees nothing. When displaying images for the right eye, the right eye sees images while the left eye sees nothing, thus the left and right eyes can sees images intended for the separate eye. Because of the persistence of vision of human eyes, human brain can process and integrate such images into stereoscopic 3D images. From the above principle of 3D technology, it is known that in order to present a sync signal from the screen, the control center of the glasses decides which grass is to open or close. Recently, the screen refresh rate of 3D TVs on the market is 120 HZ in common, whereas the screen refresh rate of most of the 2D TVs is only 60 HZ, and even without sync signal generating circuit. Thus, it is impossible to display 3D videos on a 2D display device, if displacing display devices to display 3D videos, it would definitely result in a waste of lots of 2D TVs or display devices.

### SUMMARY OF THE INVENTION

In view of the above-described problems, it is one objective of the invention to provide a shutter 2D to 3D video conversion box.

To achieve the above objective, in accordance with one embodiment of the invention, there is provided a shutter 2D to 3D video conversion box comprising an interface module, a decoding module, a control module, a sync signal amplifying and transmission module, and a sync signal receiving and processing module. The interface module, the sync signal amplifying and transmission module, and the control module are connected to the decoding module; the interface module comprises a HDMI signal input module and a HDMI signal output module; the decoding module is a main module which converts 2D video signals into 3D digital signals; the control module controls the decoding process systematically, and generates and transmits sync signals; the sync signal amplifying and transmission module amplifies and transmits sync signals. The sync signal receiving and processing module receives and processes the sync signals sent from the control module, so that the switch of left and right glasses is specifically synchronized with images intended for separate eyes sent from the decoding module.

In a class of this embodiment, the sync signal receiving and processing module is a pair of shutter glasses comprising an 8051 single chip microcomputer and an infrared receiving unit.

In a class of this embodiment, each glass of the shutter glasses is a TFT screen.

In a class of this embodiment, the 8051 single chip microcomputer comprises a lithium battery, and keys which are designed to manage the charge and discharge of the battery, the switch of the whole module, the actuation of the liquid crystal screen, and the generation of the high or low voltage and the like.

Advantages of this invention are summarized below: 1. converting the 2D video signals to 3D signals; 2. displaying 3D effects on common 2D TVs/displaying devices; 3. inputting 3D signals to 2D TVs/displaying devices to displaying 3D effects. Thus, only with the help of an input device, for example, a video player that can play 2D videos, and an output device, for example, a 2D TV set, the invention can convert 2D video signals to 3D video signals which are applicable to the 2D TV set, and further using a pair of shutter glasses, the audience can experience 3D effects. Significantly, resource wastes resulting from the displacement of the display devices is avoided, which meets the main trend of the global energy conservation.

### BRIEF DESCRIPTION OF THE DRAWINGS

FIG. 1 is a schematic diagram of a shutter 2D to 3D video conversion box of this invention;

FIG. 2 is a schematic diagram of the shutter glasses of this invention, in which L TFT represents a left glass, and R TFT represents a right glass.

### DETAILED DESCRIPTION OF THE EMBODIMENTS

For further illustrating the invention, experiments detailing a shutter 2D to 3D video conversion box are described below. It should be noted that the following examples are intended to describe and not to limit the invention.

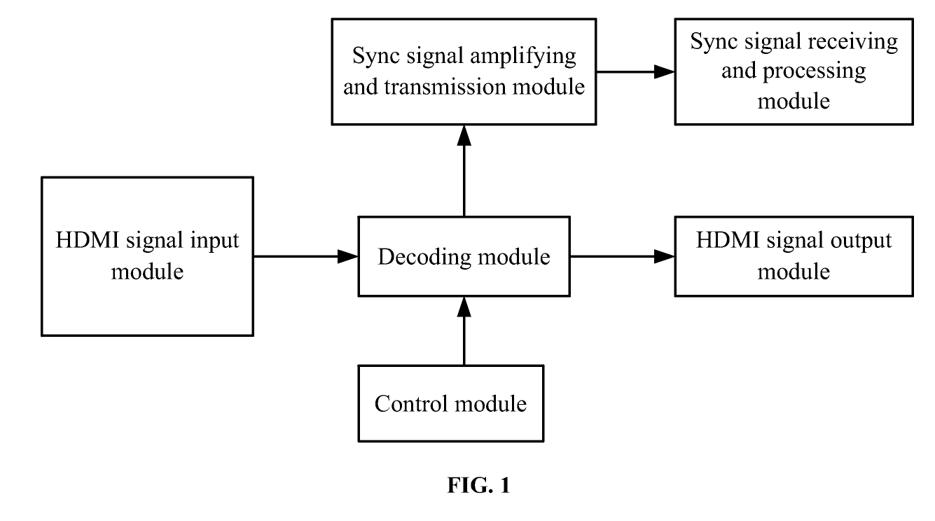

As shown in FIG. 1, a shutter 2D to 3D video conversion box comprises an interface module, a decoding module, a control module, a sync signal amplifying and transmission module, and a sync signal receiving and processing module. The operating process of the system is as follows: an HDMI signal input module of the interface module inputs a 2D video stream to the decoding module, under the control of the control module, the decoding module first produces depth of field data of the video stream according to original images, the depth of field data are then sent to a video acceleration and rendering unit, finally, each image frame of the data stream produces a second mirror image frame, thus a left and a right image frames come out; at the same time, the system adds mark signals to each of the image frame, namely, sync signals. The decoder outputs coded 3D video images via an HDMI output module, and the sync signal amplifying and transmission module sends the sync signals to the shutter glasses at the same time, to provide specific control on the switch of the left and right glasses, thus the synchronization of the on/off of each glass is realized, and the audience can have an experience of real 3D TVs.

As the decoding module sends out the decoded 3D video images via the HDMI output module, the sync signal is sent to the shutter glasses through the sync signal amplifying and transmission module.

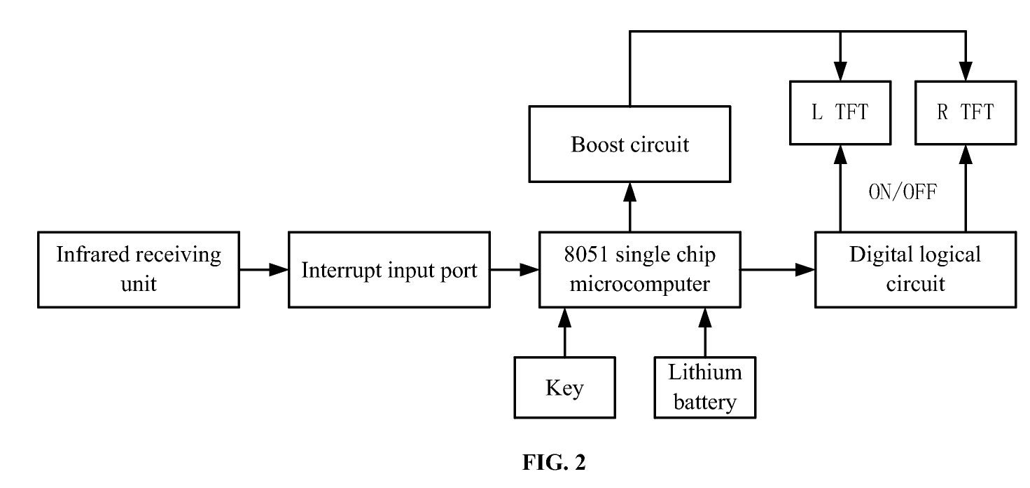

As shown in FIG. 2, an infrared receiving unit of the shutter glasses receives sync signals sent from the sync signal amplifying and transmission module, and the sync signals are transmit to an 8051 single chip microcomputer via an interrupt input port. After judging and decoding the sync signals, the 8051 single chip microcomputer outputs PWM signals, which are then sent to a digital logical circuit for logical judgment and phase locking of high level and low level. Thereafter, the data logical circuit outputs switching signals to each glass, and at the same time actuates a boost circuit to apply a voltage of 10-12 V or 0 V to the TFT screen, so that the synchronization between the switch of each of the glass and the left and right images sent from the decoding module can be realized.

Furthermore, the 8051 single chip microcomputer comprises lithium battery and keys. The design of the keys is to manage the charge and discharge of the lithium battery, the switch on/off of the whole module, the actuation of the liquid crystal screen, and the generation of high and low voltage.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A 2D to 3D video conversion box, comprising:
a) an interface module;
b) a decoding module;
c) a control module;
d) a sync signal amplifying and transmission module; and
e) a sync signal receiving and processing module;
wherein
said interface module, said sync signal amplifying and transmission module, and said control module are connected to said decoding module; and
said interface module comprises a HDMI signal input module and a HDMI signal output module;
said decoding module converts 2D video signals into 3D digital signals;
said control module controls the decoding process, and generates and transmits sync signals;
said sync signal amplifying and transmission module amplifies and transmits said sync signals; and
said sync signal receiving and processing module receives and processes said sync signals sent from said control module.

2. The 2D to 3D video conversion box of claim 1, wherein said sync signal receiving and processing module is a pair of shutter glasses comprising an 8051 single chip microcomputer and an infrared receiving unit.

3. The 2D to 3D video conversion box of claim 2, wherein said 8051 single chip microcomputer comprises a lithium battery.

4. The 2D to 3D video conversion box of claim 2, wherein each glass of said shutter glasses is a TFT screen.
